(19) United States
(12) Patent Application Publication
(10) Pub. No.: US 2018/0192013 A1
(43) Pub. Date: Jul. 5, 2018

(54) IMAGE DISPLAY DEVICE AND IMAGE DISPLAY METHOD

(71) Applicant: NEC Display Solutions, Ltd., Tokyo (JP)

(72) Inventors: Atsushi Kato, Tokyo (JP); Tomohiro Nakagawa, Tokyo (JP)

(21) Appl. No.: 15/741,105

(22) PCT Filed: Jul. 21, 2015
(86) PCT No.: PCT/JP2015/070734

§ 371 Date: Dec. 29, 2017

(51) Int. Cl. H04N 9/31

(52) U.S. Cl. CPC H04N 9/3123; H04N 9/3111; H04N 9/3105; H04N 9/3188

(57) ABSTRACT

The image display device of the present invention includes: a light source unit; image formation means that is provided with a pixel region made up of a plurality of pixels, light supplied from the light source unit being incident to this pixel region, and an image being formed by the modulation of the incident light by each of the pixels; and a control means (10) that controls the image-forming operation of the image formation means. The control means causes formation of an image with pixel combinations formed from a plurality of pixels as pixel units and individually controls the ON state and OFF state of each pixel that makes up the pixel combinations.

### TECHNICAL FIELD

The present invention relates to an image display device that is provided with a display element such as a Digital Mirror Device (DMD) and to an image display method of this image display device.

### BACKGROUND ART

Patent Document 1 discloses a single-panel projector as one example of an image display device. This single-panel projector includes a light source, a color wheel, a DMD, and a projection optical system.

The color wheel includes a wheel unit provided with a red filter region, a green filter region, and a blue filter region and is configured such that, by the rotation of this wheel unit, white light from the light source is successively irradiated into each color filter region to successively emit red (R) light, green (G) light, and blue (B) light. The light (RGB) that is emitted by the color wheel is irradiated into the DMD.

The DMD has a plurality of micromirrors, each of which forms a pixel. The micromirrors are configured to change in angle according to the drive voltage, the angle of reflection changing when a drive voltage that indicates the ON state is supplied and when a drive voltage that indicates the OFF state is supplied. Through the ON/OFF control of each micromirror according to a video signal, the irradiated luminous flux is spatially modulated to form an image.

The image formation operation of the DMD is carried out in synchronization with the rotation operation of the color wheel. The DMD successively forms a red image, a green image, and a blue image on the basis of image frames that correspond to each of the red, green and blue colors. The projection optical system enlarges and projects the red image, green image, and blue image that are formed by the DMD upon a screen.

A DMD is normally driven by a pulse width modulation (PWM) method and is capable of, for example, 256-(8-bit-) gradation display. By means of PWM 8-bit gradation display, a single image (one field) is made up of eight binary images (subfields). In each subfield, weighting, i.e., variation of the luminance can be implemented by the temporal length of the interval in which a mirror is ON (lighted), or by the number of pulses of lighting in this interval. Each subfield has a weighting (luminance) of “1,” “2,” “4,” “8,” “16,” “32,” “64,” or “128” according to the binary system. The DMD displays half-tones by combining of lighted subfields.

Recently, demand has been increasing not only for an improvement in the number of pixels, but also for a wider dynamic range (the luminance ratio of black and white that can be displayed) and for a high gradation display to raise the texture of an image.

### LITERATURE OF THE PRIOR ART

### Patent Documents

Patent Document 1: Japanese Unexamined Patent Application Publication No. 2003-102030

### Disclosure of Invention

In the projector disclosed in Patent Document 1, 8-bit gradation display is enabled by driving a DMD by the PWM method. In a PWM gradation display, however, the temporal length (pulse width) of the interval of a subfield having a weighting (luminance) of “1,” which is the minimum bit, must be at least the temporal length that is determined by the response speed of the DMD. This constraint of the subfield interval that is based on the DMD response speed complicates realizing a high-gradation display of, for example, 512 gradations or more in the projector disclosed in Patent Document 1.

It is an object of the present invention to provide an image display device and image display method capable of high-gradation display with a broad dynamic range and thus solve the above-described problem.

In order to achieve the above-described object, according to an aspect of the present invention, an image display device is provided that includes:

a light source unit;

image formation means that is provided with a pixel region made up of a plurality of pixels, this pixel region being irradiated by light that is supplied from the light source unit, and an image being formed by modulation of incident light by each pixel; and

control means that controls the image formation operation of the image formation means; wherein the control means causes formation of an image with pixel combinations formed by a plurality of pixels as pixel units and individually controls the ON state and OFF state of each pixel of the pixel combinations.

According to another aspect of the present invention, an image display method is provided that is an image display method carried out in an image display device provided with a pixel region that is made up of a plurality of pixels and in which an image is formed by the modulation of incident light by each pixel;

wherein an image is formed in the pixel region with pixel combinations that are formed by a plurality of pixels as pixel units, and the OFF state and ON state of each pixel that makes up the pixel combinations are individually controlled.

### BRIEF DESCRIPTION OF THE DRAWINGS

FIG. 1 is a schematic view showing the block configuration of the optical system of an image display device according to the first example embodiment of the present invention.

FIG. 2 is a block diagram showing the configuration of processing/control portion of the image display device according to the first example embodiment of the present invention.

FIG. 3A is a schematic view showing an example of an image that is formed by a DMD panel.

FIG. 3B is a schematic view showing an example of an image formed by a DMD panel with pixel combinations made up by four pixels in two rows and two columns as pixel units.

FIG. 4 is a schematic view showing an example of luminance levels that can be achieved by pixel combinations.

FIG. 5 is timing chart that shows the operation of each mirror of a pixel combination when the luminance is 50%.

FIG. 6 is a view for describing an example of the modulation operation for a case in which luminance control of pixel combinations composed of four pixels in two rows and two columns is combined with PWM modulation control that performs 8-bit gradation display.

FIG. 7 is a view for describing change over time of colored light that is irradiated upon a DMD panel.

FIG. 8 is a schematic view showing a block configuration of the optical system of an image display device according to the second example embodiment of the present invention.

FIG. 9A is a schematic view showing an example of a phosphor wheel.

FIG. 9B is a schematic view showing an example of a color wheel.

FIG. 10 is a block diagram showing the configuration of the processing/control portion of the image display device according to the second example embodiment of the present invention.

FIG. 11 is a view for describing the change over time of colored light that is irradiated upon two DMD panels.

FIG. 12 is a schematic view showing the block configuration of the optical system of the image display device according to the third example embodiment of the present invention.

FIG. 13 is a perspective view showing the arrangement of the TIR prism, DMD, and cross-dichroic prism of the projector shown in FIG. 12.

FIG. 14 is a schematic view showing the optical path of green light incident to the cross-dichroic prism in the projector shown in FIG. 12.

FIG. 15 is a block diagram showing the configuration of the processing/control portion of the image display device according to the third example embodiment of the present invention.

FIG. 16 is a view for describing the operation of the image display device according to the fourth example embodiment of the present invention.

FIG. 17A is a schematic view showing the image formation region that forms a portion of an image based on one image signal.

FIG. 17B is a schematic view showing the image formation region that forms a portion of an image based on another image signal.

### DESCRIPTION OF EXAMPLE EMBODIMENTS

Example embodiments of the present invention are next described with reference to the accompanying drawings.

### First Example Embodiment

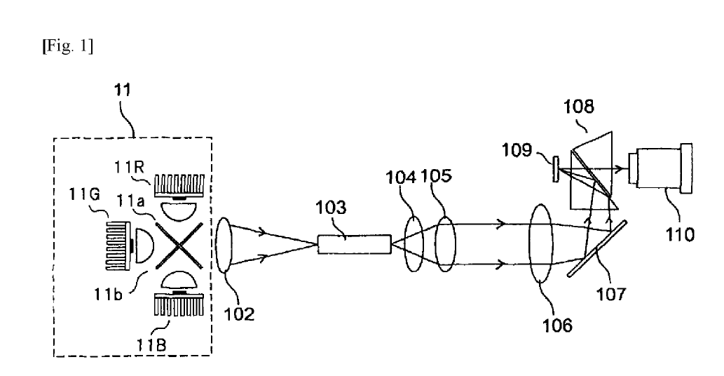

FIG. 1 is a schematic view showing the block configuration of the optical system of the image display device according to the first example embodiment of the present invention.

Referring to FIG. 1, the image display device is a single-panel DLP projector and includes: light source unit 11, condensing lens 102, light tunnel 103, lens systems 104-106, reflecting mirror 107, TIR (Total Internal Reflection) prism 108, DMD panel 109, and projection lens 110.

Light source unit 11 includes dichroic mirrors 11a and 11b and light sources 11R, 11G, and 11B. Each of light sources 11R, 11G, and 11B includes a solid-state light source such as a laser diode (LD) or a light-emitting diode (LED) and a collimator lens for converting the output light of the solid-state light source to parallel luminous flux. Light source 11R supplies red light, light source 11G supplies green light, and light source 11B supplies blue light. Light source 11R is arranged to face light source 11B. Light sources 11R, 11G, and 11B may light up continuously or each of the lights may light up individually.

The green light beam from light source 11G intersects at approximately 90° with each of the red light beam from light source 11R and the blue light beam from light source 11B. Dichroic mirrors 11a and 11b are provided at the position at which the green light beam intersects the red light beam and the blue light beam. Dichroic mirror 11a has spectral reflectance properties of reflecting light of the red wavelength band and transmitting light of the green wavelength band and light of the blue wavelength band. Dichroic mirror 11b has spectral reflectance properties of reflecting light of the blue wavelength band and transmitting light of the red wavelength band and light of the green wavelength band.

The red light that is supplied by light source 11R is incident to one surface of dichroic mirror 11a at an angle of incidence of approximately 45°, and green light supplied by light source 11G and blue light supplied by light source 11B are each incident to the other surface of dichroic mirror 11a at an angle of incidence of approximately 45°. In addition, the blue light supplied by light source 11B is incident to one surface of dichroic mirror 11b at an angle of incidence of approximately 45°, and the red light supplied from light source 11R and the green light supplied from light source 11G are each incident to the other surface of dichroic mirror 11b at an angle of incidence of approximately 45°. Here, the angle of incidence is the angle formed by an incident ray and the normal to the point of incidence.

Condensing lens 102 is arranged between light source unit 11 and light tunnel 103 and converges the light from light source unit 11 and causes the light to irradiate light tunnel 103. In FIG. 1, condensing lens 102 is made up by a single lens, but the present invention is not limited to this form. Condensing lens 102 may also be made up of a plurality of lenses.

Light tunnel 103 is a light-homogenizing element, one end surface being the incident surface and the other end surface being the emission surface. The red light that is supplied from light source 11R is reflected by dichroic mirror 11a, and this reflected light is irradiated into the incident surface of light tunnel 103 by way of condensing lens 102. The blue light that is supplied from light source 11B is reflected by dichroic mirror 11b, and this reflected light is irradiated into the incident surface of light tunnel 103 by way of condensing lens 102. The green light supplied from light source 11G is transmitted by dichroic mirrors 11a and 11b and is irradiated into the incident surface of light tunnel 103 by way of condensing lens 102. Light tunnel 103 may also be made up of a hollow mirror or a solid glass rod. An integrator optical system that uses a fly-eye lens may also be used in place of light tunnel 103.

TIR prism 108 is a total-reflection prism assembly provided with total reflection surfaces in its interior and contains two triangular prisms. One of the triangular prisms is a right-angle prism and has first and second surfaces that make up the sides that form a right angle and a third surface that makes up the hypotenuse. The other right-angle prism has first to third surfaces that make up each line of a triangle. The third surface of the right-angle prism is arranged to face the first surface of the other triangular prism. The first surface of the right-angle prism is the incident surface of TIR prism 108, and DMD panel 109 is arranged to face the second surface of the right-angle prism. The second surface of the other triangular prism is the emission surface of TIR prism 108 and is parallel with the second surface of the right-angle prism. Projection lens 110 is arranged on the side of this emission surface. Light that is emitted from the emission surface of light tunnel 103 is incident to the incident surface of TIR prism 108 by way of lens systems 104-106 and reflecting mirror 107. The light that is incident to TIR prism 108 undergoes total reflection by the internal total-reflection surfaces and is emitted from the second surface of the right-angle prism. This light that is emitted from the second surface is irradiated into DMD panel 109.

Light tunnel 103 is a component for homogenizing the illumination distribution on the cross section of the luminous flux that is irradiated upon DMD panel 109. Rectangular illumination information in which the illumination distribution is uniform is formed in the vicinity of the emission end of light tunnel 103. This rectangular illumination information forms an image on DMD panel 109 by means of lens systems 104-106. The shape specifications (such as the curvature and material) and the number of lenses of lens systems 104-106 should be optimized as appropriate.

DMD panel 109 has a pixel region made up of a plurality of micromirrors that are arranged in matrix form, each micromirror forming a pixel. The micromirrors are formed such that their angles change according to the drive voltage, the reflection angle changing for cases in which a drive voltage that indicates the ON state is supplied and cases in which a drive voltage that indicates the OFF state is supplied. An image is formed by spatial modulation of the incident luminous flux by the ON/OFF control of each micromirror according to the video signal.

An image formed on DMD panel 109 is enlarged and projected upon a screen (not shown) by projection lens 110 by way of TIR prism 108.

The configuration of the processing/control portion relating to the display operation of the image display device of the present example embodiment is next described.

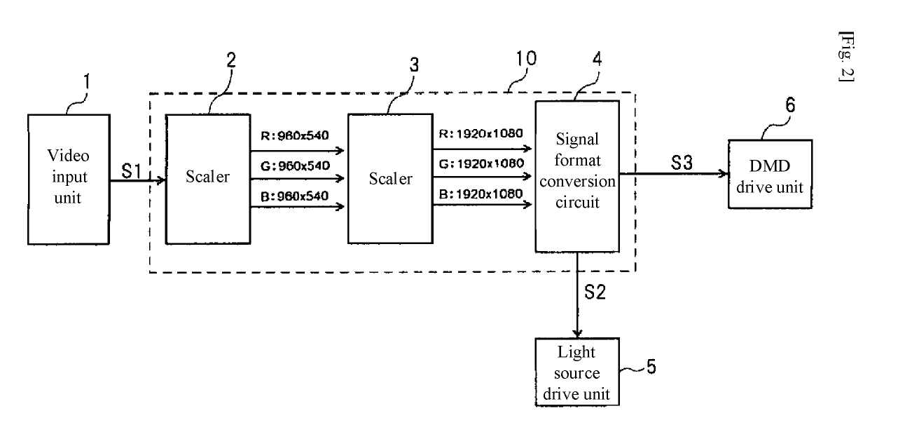

FIG. 2 is a block diagram showing the configuration of the processing/control portion of the image display device of the present example embodiment.

Referring to FIG. 2, the image display device includes: video input unit 1; light source drive unit 5 that drives each of light sources 11R, 11G, and 11B; DMD drive unit 6 that drives DMD panel 109; and control unit 10 that controls the light output operation of the light sources and the image-forming operation of DMD panel 109. Control unit 10 includes scalers 2 and 3 and signal format conversion circuit 4.

Video input unit 1 receives a video signal from an outside device and supplies video signal S1 to scaler 2. The outside device is a personal computer or an image apparatus such as a recorder.

Scalers 2 and 3 are resolution conversion circuits that convert the resolution of video signal S1 to the optimum resolution for display on DMD panel 109. In the interest of convenience, DMD panel 109 here has [1920 (horizontal)×1080 (vertical)] micromirrors and is configured to enable provision of, at a maximum, resolution referred to as full HD (High Definition). However, the resolution of DMD panel 109 is not limited to full HD.

Scaler 2 converts the resolution of video signal S1 to the resolution of QHD (Quarter High Definition) that is one-quarter the resolution (full HD) that is determined by the number of pixels (1920×1080) of DMD panel 109. Scaler 2 supplies an RGB signal of resolution (960×540) to scaler 3.

Scaler 3 converts the resolution of each of the RGB signals supplied from scaler 2 to the same resolution as the full HD that is the maximum resolution of DMD panel 109. Scaler 3 supplies an RGB signal of the resolution (1920×1080) to signal format conversion circuit 4.

Light source drive unit drives each of light sources 11R, 11G, and 11B, and DMD drive unit 6 drives DMD panel 109. On the basis of an RGB signal of resolution (1920×1080), signal format conversion circuit 4 both controls the image-forming operation of DMD panel 109 realized by DMD drive unit 6 and controls the light source drive operation realized by light source drive unit 5 in synchronization with this image-forming operation. The control of light source drive unit 5 is implemented on the basis of light source control signal S2, and the control of DMD drive unit 6 is implemented on the basis of DMD control signal S3.

In the control of the image-forming operation, signal format conversion circuit 4 causes formation of images on the basis of the RGB signals with, as pixel units, pixel combinations that are formed by a plurality of pixels, for example, pixel combinations formed from four adjacent pixels in two rows and two columns. Signal format conversion circuit 4 then performs the ON/OFF control necessary for gradation display with respect to each micromirror that makes up the pixel combinations.

Further, in the control of the light source drive operation, signal format conversion circuit 4 causes lighting of light sources 11R, 11G, and 11B in time divisions in synchronization with the image-forming operation. As a result, images of each of the colors red, green, and blue and having QHD resolution (960×540) are sequentially formed on a pixel region composed of (1920×1080) micromirrors in DMD panel 109.

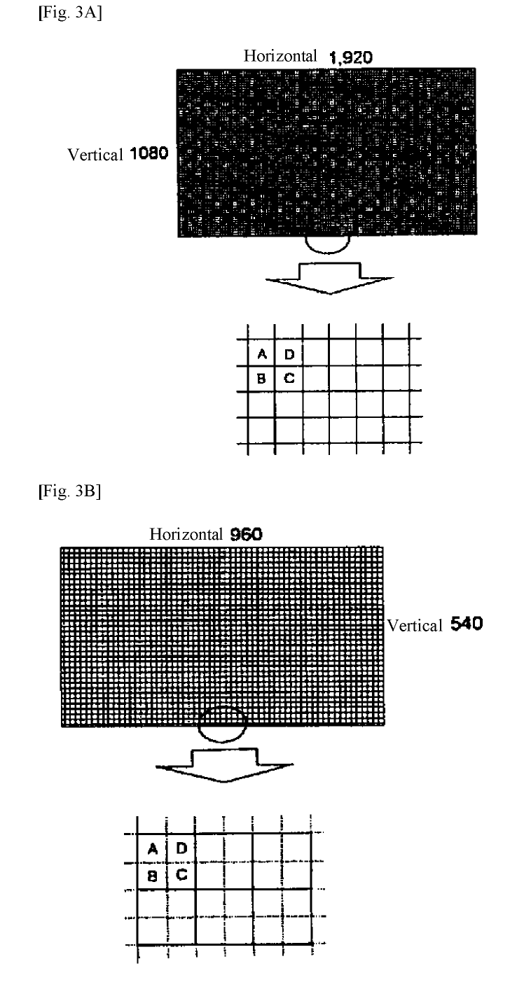

FIG. 3A gives a schematic representation of an image of the maximum resolution that is formed by DMD panel 109, and FIG. 3B gives a schematic representation of an image formed by DMD panel 109 when pixel combinations each composed of four pixels in two rows and two columns are taken as the pixel units.

As shown in FIG. 3A, DMD panel 109 can form an image of resolution of 1920 (horizontal)×1080 (vertical) at maximum. As shown in FIG. 3B, signal format conversion circuit 4 causes the formation of an image on DMD panel 109 with pixel combinations that are each formed by four pixels A, B, C, and D in two rows and two columns as the pixel units. The resolution of the image in this case is 960 (horizontal)×540 (vertical) and is thus lower than that of the image shown in FIG. 3A. However, because pixels A, B, C, and D that make up a pixel combination can be individually controlled, the number of gradations of the image can be made greater than that of the image shown in FIG. 3A.

FIG. 4 gives a schematic representation of the luminance levels that can be achieved by a pixel combination. The pixel combination is made up of four micromirrors corresponding to pixels A, B, C, and D, and five steps of the luminance levels 0%, 25%, 50%, 75%, and 100% can be achieved by means of the ON/OFF states of each micromirror. Here, 0% indicates a state (black display state) in which all four micromirrors are OFF. 25% indicates a state in which one of the four micromirrors is ON and the remaining three are OFF. 50% indicates a state in which two of the four micromirrors are ON and the remaining two are OFF. 75% indicates a state in which three of the four micromirrors are ON and the remaining micromirror is OFF. 100% indicates a state in which all four micromirrors are ON.

FIG. 4 gives a schematic representation of patterns that indicate the ON/OFF states of the four micromirrors in each of the luminance levels 0%, 25%, 50%, 75%, and 100%. In these patterns, the four boxes shown by broken lines each correspond to a micromirror, “0” indicates OFF, and “1” indicates ON.

The state of 25% has four patterns. In the first pattern, the upper left mirror, the lower left mirror, the upper right mirror, and the lower right mirror are in the states of 1, 0, 0, and 0, respectively. In the second pattern, the upper left mirror, the lower left mirror, the upper right mirror, and the lower right mirror are in the states of 0, 1, 0, and 0, respectively. In the third pattern, the upper left mirror, the lower left mirror, the upper right mirror, and the lower right mirror are in the states of 0, 0, 0, and 1, respectively. In the fourth pattern, the upper left mirror, the lower left mirror, the upper right mirror, and the lower right mirror are in the states of 0, 0, 1, and 0, respectively. By using any of these first to fourth patterns, a pixel combination of 25% luminance can be provided.

The state of 50% has six patterns. The first pattern indicates a state in which the upper left mirror, the lower left mirror, the upper right mirror, and the lower right mirror are set to 1, 1, 0, and 0, respectively. The second pattern indicates a state in which the upper left mirror, the lower left mirror, the upper right mirror, and the lower right mirror are set to 0, 1, 0, and 1, respectively. The third pattern indicates a state in which the upper left mirror, the lower left mirror, the upper right mirror, and the lower right mirror are set to 0, 0, 1, and 1, respectively. The fourth pattern indicates a state in which the upper left mirror, the lower left mirror, the upper right mirror, and the lower right mirror are set to 1, 0, 1, and 0, respectively. The fifth pattern indicates a state in which the upper left mirror, the lower left mirror, the upper right mirror, and the lower right mirror are set to 1, 0, 0, and 1, respectively. The sixth pattern indicates a state in which the upper left mirror, the lower left mirror, the upper right mirror, and the lower right mirror are set to 0, 1, 1, and 0, respectively. A pixel combination of 50% luminance can be provided by using any of these first to sixth patterns.

The state of 75% luminance has four patterns. The first pattern indicates a state in which the upper left mirror, the lower left mirror, the upper right mirror, and the lower right mirror are set to 0, 1, 1, and 1, respectively. The second pattern indicates a state in which the upper left mirror, the lower left mirror, the upper right mirror, and the lower right mirror are set to 1, 0, 1, and 1, respectively. The third pattern indicates a state in which the upper left mirror, the lower left mirror, the upper right mirror, and the lower right mirror are set to 1, 1, 1, and 0, respectively. The fourth pattern indicates a state in which the upper left mirror, the lower left mirror, the upper right mirror, and the lower right mirror are set to 1, 1, 0, and 1, respectively. A pixel combination of 75% luminance can be provided by using any of these first to fourth patterns.

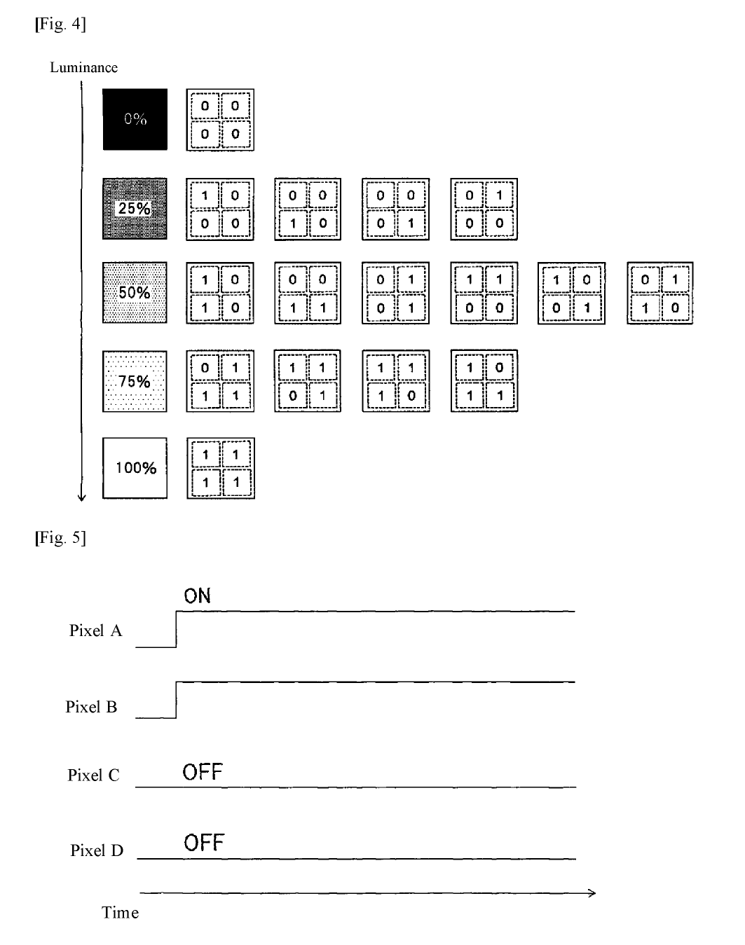

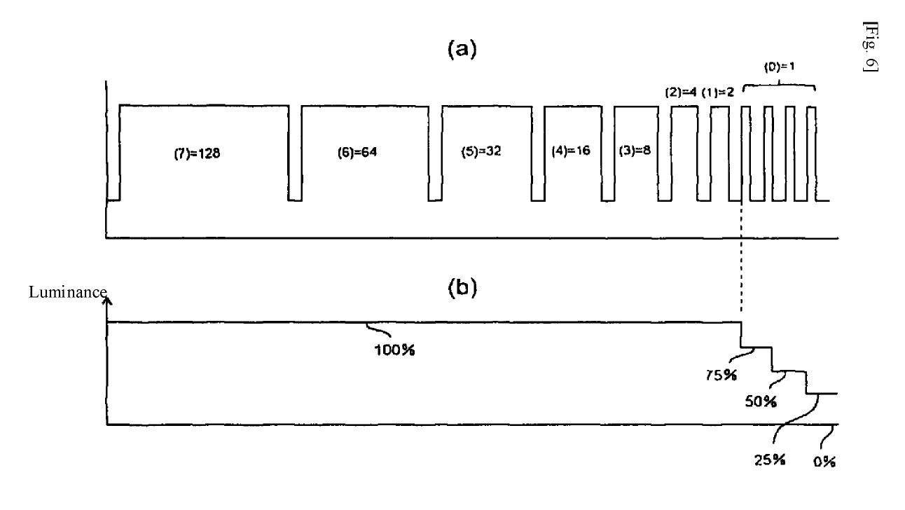

As one example, FIG. 5 shows the operation of each mirror of a pixel combination when the luminance is 50%. In this example, the pixel combination is made up of four pixels (micromirrors) A, B, C, and D in two rows and two columns. Drive voltage that indicates the ON state is supplied to pixels A and B and drive voltage that indicates the OFF state is supplied to pixels C and D. The drive of this example is equivalent to drive based on the first pattern of 50% luminance shown in FIG. 4.

In the image display device of the present example embodiment, signal format conversion circuit 4 executes a process of individually controlling each pixel of the pixel combination to change the luminance of the pixel combination (luminance control of the pixel combination) and a process of driving each pixel of the pixel combination by PWM to carry out gradation display (PWM modulation control).

In PWM modulation control, a field that is the time unit for displaying a one-frame image is made up of a plurality of subfields provided with time widths that each correspond to a plurality of bits, and signal format conversion circuit 4 generates a modulation signal that prescribes a plurality of gradations by means of the combination of the subfields. The modulation signal is generated on the basis of an RGB signal (bit signal) from scaler 3.

For example, when causing the formation of the image (blue image) shown in FIG. 3B on the basis of a B signal (bit signal), signal format conversion circuit 4 generates a modulation signal that prescribes the luminance value of the pixel combination by means of subfields that are provided with time widths that correspond to the luminance value. Signal format conversion circuit 4 then performs ON/OFF control of each pixel of the pixel combination on the basis of the modulation signal. The implementation of eight-bit gradation display (256 gradations) can thus be achieved by prescribing the gradation by the length of the pulse time widths and implementing weighting of subfields that is based on binary numbers.

The number of gradations can be further increased by combining PWM modulation control and the luminance control of pixel combinations. For example, when luminance control of pixel combinations that are composed of four pixels in two rows and two columns is combined with PWM modulation control that performs 8-bit gradation display, gradation display of 11 bits or more becomes possible. High-gradation display is thus enabled over a broad dynamic range.

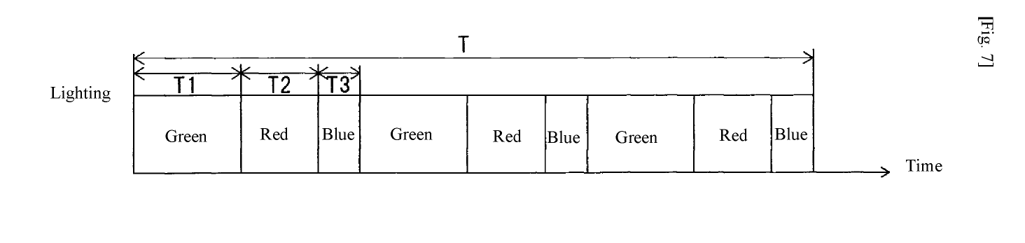

FIG. 6 shows an example of the modulation operation when luminance control of pixel combinations composed of four pixels in two rows and two columns is combined with PWM modulation control that implements 8-bit gradation display. The frame frequency is 60 Hz, and a single-frame interval is 16.67 ms. When each of red, green and blue images are displayed successively to obtain a color image, the assigned interval (subfield) of the image of each color is 5.56 ms. In FIG. 6, the upper portion (a) of the figure shows the modulation signal (modulation pattern) that indicates the drive timing of a pixel combination, and the lower portion (b) shows the luminance of the pixel combination. In portions (a) and (b) of FIG. 6, the horizontal axis shows time. In portion (b) of FIG. 6, the vertical axis shows the luminance (%) of the pixel combination.

In portion (a) of FIG. 6, the modulation signal (modulation pattern) is provided with eight subfields that constitute eight bits from (0) to (7) according to the binary system. These subfields are each given a time width having the weightings (luminance) “1,” “2,” “4,” “8,” “16,” “32,” “64,” and “128.”

Each pixel combination of DMD panel 109 displays a half-tone by combining subfields on the basis of the modulation signal. For example, the luminance corresponding to “173” is obtained by setting the micromirror to the ON state in the subfield for which the weighting is “128,” the subfield for which the weighting is “32,” the subfield for which the weighting is “8,” the subfield for which the weighting is “4,” and the subfield for which the weighting is “1.”

In portion (b) of FIG. 6, the luminance of the pixel combination can be displayed in the five steps of 100%, 75%, 50%, 25%, and 0%. In this example, the least significant bits (bits having a weighting of “1”) of the modulation signal are set to four, and three of these are set to correspond to 75%, 50% and 25% luminance.

Signal format conversion circuit 4 drives each micromirror of each pixel combination of DMD panel 109 on the basis of a modulation signal that prescribes the pulse width shown in portion (a) of FIG. 6. At the same time, signal format conversion circuit 4 determines the micromirrors that are to be driven according to the luminance of the pixel combination that is indicated in portion (b) of FIG. 6 for the smallest bits of the modulation signal. For example, in the case of 50% luminance, signal format conversion circuit 4 sets the micromirrors corresponding to pixels A and B to the ON state and sets the micromirror corresponding to pixels C and D to the OFF state as shown in FIG. 5 for the smallest bits of the modulation signal. In this way, the gradation expression of the total of 11 bits, i.e., 2048 gradations, can be realized.

Further, although the drive control of DMD panel 109 is carried out with pixel combinations as the unit pixels for each of the red, green, and blue images in the present example embodiment, the present invention is not limited to this form. For example, drive control that uses a pixel combination may be carried out for the images of at least one color among the images of each of the colors red, green, and blue.

Typically, when solid-state light sources such as LEDs are used as light sources 11R, 11G, and 11B, the luminance of light source 11B is higher than that of the other light sources 11R and 11G. As a result, as shown in FIG. 7, the irradiation intervals (display intervals) T1, T2, and T3 of each of the green, red, and blue in a single frame interval are set to satisfy the condition T1>T2>T3. The irradiation interval (T1+T2+T3) is one subfield interval. In this case, the constraints resulting from the micromirror response speed when the subfield frequency relating to the blue image is increased are more stringent than the constraints relating to the red or green image. The condition of the irradiation intervals T1, T2, and T3 may also be T2>T1>T3.

In addition, although gradation display can be improved when drive control that uses pixel combinations is carried out, the resolution conversely drops. Due to the visibility characteristics of the human eye, with regard to the color blue, the human eye has lower sensitivity and greater difficulty perceiving a decrease of resolution.

Taking into consideration the stringency of the above-described constraints and this insensitivity to any decrease in the resolution of blue, drive control that uses pixel combinations is preferably carried out only for blue images. In this case, signal format conversion circuit 4 causes formation on DMD panel 109 of images of resolution (1920×1080) during display intervals of red images and green images and causes formation on DMD panel 109 of images with pixel combinations formed from a plurality of pixels as pixel units in the display intervals of blue images. For example, when pixel combinations are formed from four pixels in two rows and two columns, signal format conversion circuit 4 causes formation on DMD panel 109 of blue images having QHD resolution (960×540). Signal format conversion circuit 4 then implements ON/OFF control required for gradation display for each micromirror that makes up pixel combinations, whereby resolution can be guaranteed for green and red images and any decrease of resolution can be reduced when observing color images.

In the present example embodiment, moreover, the luminance that can be achieved by pixel combinations composed of four pixels in two rows and two columns was prescribed by the five states of 0%, 25%, 50%, 75%, and 100%, but the luminance is not necessarily limited to these five states. For example, the luminance that can be achieved by pixel combinations may also be prescribed by the combinations of three or more states among the five states. For example, the luminance that can be achieved by pixel combinations may be prescribed by the three states of 0%, 50%, and 100%, or by the three states of 0%, 75%, and 100%. In this case, the subfield interval necessary for representing 256 gradations becomes longer than 0.74 ms, but the effects are maintained of raising the subfield frequency to largely decrease color breaking, and moreover, maintaining or improving the quality of gradation display.

In addition, although resolution conversion was carried out by scalers 2 and 3 in the present example embodiment, signal format conversion circuit 4 may also be provided with a resolution conversion capability similar to scalers 2 and 3. In this case, when a video signal of resolution identical to the maximum resolution of DMD panel 109 is supplied from an outside device to signal format conversion circuit 4, signal format conversion circuit 4 may form on DMD panel 109 images with pixel combinations formed from a plurality of pixels as the pixel units without resolution conversion.

### Second Example Embodiment

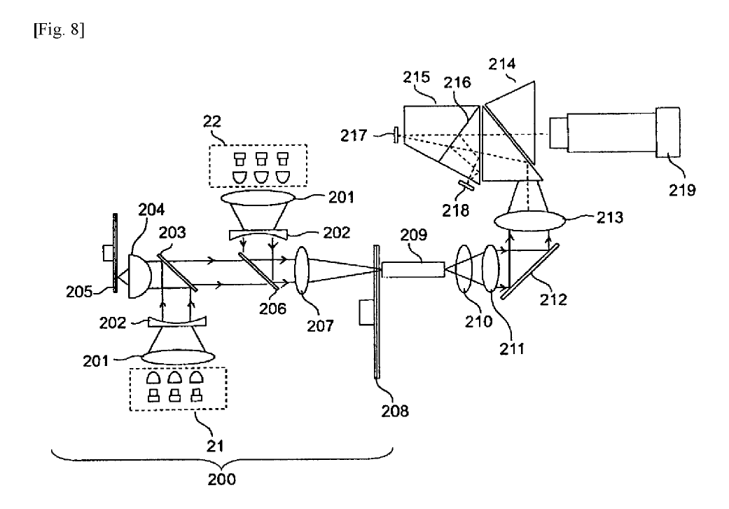

FIG. 8 is a schematic view showing the block configuration of the optical system of the image display device according to the second example embodiment of the present invention.

Referring to FIG. 8, the image display device is a two-panel projector and includes: light source unit 200; light tunnel 209; lens systems 210, 211, and 213; reflecting mirror 212; TIR prism 214; dichroic prism 215; DMD panels 217 and 218; and projection lens 219. Light source unit 200 includes: laser light sources 21 and 22; lens systems 201a, 201b, 202a, and 202b; dichroic mirrors 203 and 206; condensing lenses 204 and 207; phosphor wheel 205; and color wheel 208.

Laser light sources 21 and 22 are each made up of a plurality of blue semiconductor lasers. When the number of blue semiconductor lasers is increased, the light output intensity of light sources 21 and 22 increases.

The beam diameter of blue light supplied from light source 21 is converted by lens systems 201a and 202a to parallel luminous flux. The blue light that has passed through lens systems 201a and 202a is irradiated upon dichroic mirror 203 at an angle of incidence of approximately 45°. Dichroic mirror 203 has the spectral reflectance characteristic of reflecting, of the visible wavelength band, light of the blue wavelength band and of transmitting light of other wavelength bands.

Dichroic mirror 203 reflects blue light that is incident from light source 21 by way of lens systems 201a and 202a. The reflected blue light from dichroic mirror 203 is converged upon phosphor wheel 205 by condensing lens 204.

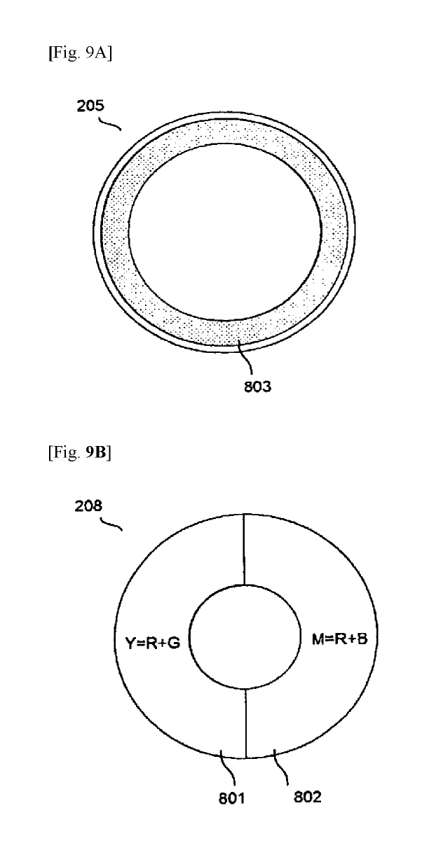

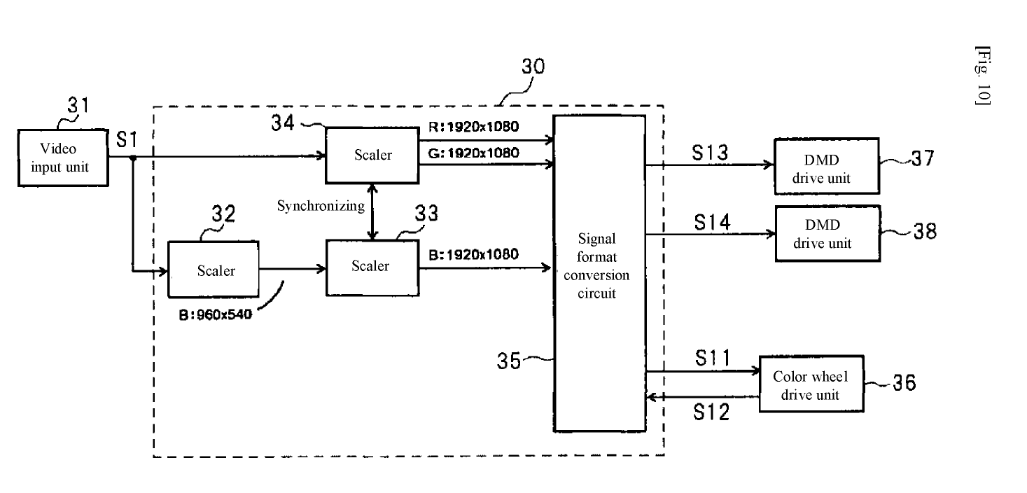

FIG. 9A gives a schematic representation of phosphor wheel 205. As shown in FIG. 9A, phosphor wheel 205 has yellow phosphor region 803 that contains a phosphor that is excited by excitation light (for example, blue light) to emit yellow fluorescent light. Yellow phosphor region 803 is formed in the circumferential direction and is an overall ring shape.

Blue light that is focused by condensing lens 204 is irradiated upon yellow phosphor region 803 while phosphor wheel 205 is rotated at a predetermined speed. The yellow fluorescent light that is emitted from yellow phosphor region 803 is incident to dichroic mirror 203 by way of condensing lens 204. The yellow fluorescent light contains a green component (green spectrum) and red component (red spectrum). The yellow fluorescent light is transmitted through dichroic mirror 203.

The beam diameter of the blue light that is supplied from light source 22 is converted by lens systems 201b and 202b to parallel luminous flux. The light beam of the blue light that has been transmitted through lens systems 201b and 202b intersects the light beam of the yellow fluorescent light that has been transmitted through dichroic mirror 203, and dichroic mirror 206 is arranged at this point of intersection.

The yellow fluorescent light that has been transmitted through dichroic mirror 203 is incident to one surface of dichroic mirror 206 at an angle of incidence of approximately 45°. The blue light that has been transmitted through lens systems 201b and 202b is incident to the other surface of dichroic mirror 206 at an angle of incidence of approximately 45°. Similar to dichroic mirror 202, dichroic mirror 206 has the spectral reflectance characteristics of reflecting, of the visible wavelength band, light of the blue wavelength band and transmitting light of other wavelength bands.

The yellow fluorescent light that has been transmitted through dichroic mirror 203 is transmitted through dichroic mirror 206. The blue light that has been transmitted through lens systems 201b and 202b is reflected by dichroic mirror 206. The yellow fluorescent light that has been transmitted through dichroic mirror 206 and the blue light that has been reflected by dichroic mirror 206 are irradiated upon condensing lens 207 on substantially the identical optical path.

Light tunnel 209 is similar to light tunnel 103 shown in FIG. 1 with one end surface being the incident surface and the other end surface being the emission surface. Condensing lens 207 focuses yellow fluorescent light and blue light upon the incident surface of light tunnel 209.

Color wheel 208 is arranged in the vicinity of the incident surface of light tunnel 209. FIG. 9B gives a schematic representation of an example of color wheel 208. As shown in FIG. 9B, color wheel 208 is divided into two in the circumferential direction, wavelength-selective film Y being formed in one divided region 801, and wavelength-selective film M being formed on the other divided region 802. Wavelength-selective film Y has the spectral transmission characteristics of transmitting light of the red wavelength band and light of the green wavelength band and reflecting or absorbing light of other wavelength bands. Wavelength-selective film M has the spectral transmission characteristics of transmitting light of the red wavelength band and light of the blue wavelength band and reflecting or absorbing light of other wavelength bands. These wavelength-selective films Y and M can be constituted by, for example, dielectric multilayer films.

Light beams (blue light and yellow fluorescent light) from condensing lens 204 are successively irradiated upon divided regions 801 and 802 of color wheel 208 while rotating color wheel 208 at a predetermined speed. Red light and green light (RG light) that have been transmitted through wavelength-selective film Y and red and blue light (RB light) that have been transmitted through wavelength-selective film M are emitted from color wheel 208 in time divisions. Further, the number of divided regions 801 and 802 and of wavelength-selective films Y and M, and the width of each wavelength-selective film in the circumferential direction can be set as appropriate.

Light that is emitted from the emission surface of light tunnel 209 is irradiated into the incident surface of TIR prism 214 by way of lens systems 210, 211, and 213 and reflecting mirror 212. TIR prism 214 is similar to TIR prism 108 shown in FIG. 1, and light that is incident from the incident surface is subjected to total reflection by the total-reflection surfaces of the interior and emitted from the second surface of the right-angle prism. The light that is emitted from this second surface is incident to dichroic prism 215.

Dichroic prism 215 is made up of a first and second prism, and dichroic film 216 having characteristics of reflecting light of the red wavelength band and transmitting light of the green wavelength band and light of the blue wavelength band is formed at the junction interface of these prisms. The first prism is a triangular prism and has first to third surfaces that make up each segment of a triangle. The second prism is a polygonal prism and has first to fourth surfaces, the first surface being arranged opposite the second surface and the third surface being arranged opposite the fourth surface.

The first surface of the first prism is arranged to face the second surface of the right-angle prism of TIR prism 108. The second surface of the first prism and the first surface of the second prism are joined, and dichroic film 216 is formed at this junction interface.

Light that is incident from the first surface of the first prism (red light, green light, and blue light) is incident to dichroic film 216. The red light that is reflected by dichroic film 216 undergoes total reflection at the first surface of the first prism and is then emitted from the third surface of the first prism. The red light that is emitted from this third surface is irradiated into DMD panel 218.

DMD panel 218 forms a red image. The red image light from DMD panel 218 is incident from the third surface of the first prism, is reflected by dichroic film 216, and is emitted from the first surface of the first prism. The red image light that is emitted from this first surface is transmitted through TIR prism 214 and is then incident to projection lens 219.

The light that is transmitted through dichroic film 216 (green light and blue light) is emitted from the second surface of the second prism. This light that is emitted from the second surface (green light and blue light) is irradiated into DMD panel 217.

DMD panel 217 successively forms a green image and a blue image. In other words, a green image and a blue image are formed in time divisions by DMD panel 217. The green and blue image light from DMD panel 217 is incident to the second surface of the second prism, transmitted through dichroic film 216, and is emitted from the first surface of the first prism. This green and blue image light that is emitted from the first surface passes through TIR prism 214 and is then irradiated into projection lens 219.

Projection lens 219 enlarges and projects the green and blue images that were formed in time divisions in DMD panel 217 and the red image that was formed in DMD panel 218.

In the present example embodiment, the light quantities of each of the red, green, and blue per unit time can be increased compared to the first example embodiment and a high-luminance color image can therefore be provided.

In addition, a diffuser can also be arranged between lens 202b and dichroic mirror 206. In this way, the speckle of laser light can be decreased, with the result that the image quality of the projected image can be improved.

The configuration of the processing control portion that relates to the display operation of the image display device of the present example embodiment is next described.

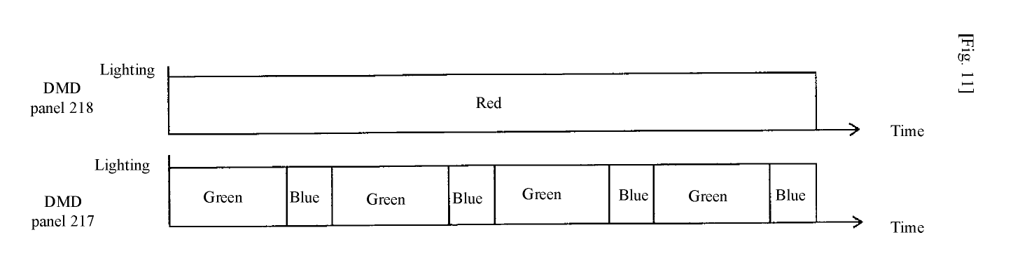

FIG. 10 is a block diagram showing the configuration of the processing/control portion of the image display device of the present example embodiment.

Referring to FIG. 10, the image display device includes control unit 30, video input unit 31, color wheel drive unit 36, and DMD drive units 37 and 38. Control unit 30 includes scalers 32, 33, and 34, and signal format conversion circuit 35.

Video input unit 31 is the same as video input unit 1 shown in FIG. 1, and receives a video signal from an outside device and supplies video signal S1 to scalers 32 and 34. The outside device is a personal computer or an image apparatus such as a recorder.

Scalers 32, 33, and 34 are resolution conversion circuits that convert the resolution of video signal Si to the optimum resolution for display on DMD panels 217 and 218. Here, for the sake of convenience, DMD panels 217 and 218 both have [1920 (horizontal)×1080 (vertical)] micromirrors and are configured to allow provision of a maximum resolution referred to as full HD (High Definition). However, the resolution of these DMD panels 217 and 218 is not limited to full HD.

Scaler 32 converts the resolution of video signal 51 to the resolution of QHD (Quarter High Definition) that is one-quarter the resolution (full HD) that is determined by the number of pixels (1920×1080) of DMD panel 217. Scaler 32 provides a B signal of resolution (960×540) to scaler 33.

Scaler 33 converts the resolution of the B signal that is supplied from scaler 32 to the same resolution as the full HD that is the maximum resolution of DMD panel 217. Scaler 33 supplies the B signal of resolution (1920×1080) to signal format conversion circuit 35.

Scaler 34 converts the resolution of video signal S1 to the same resolution as full HD that is the maximum resolution of DMD panels 217 and 218 and supplies an RG signal of resolution (1920×1080) to signal format conversion circuit 35.

Color wheel drive unit 36 rotates color wheel 208 in accordance with rotation control signal S10 from signal format conversion circuit 35 and supplies rotation rate detection signal S11 that indicates the rotation rate to signal format conversion circuit 35. DMD drive unit 37 drives DMD panel 217 in accordance with DMD control signal S13 from signal format conversion circuit 35. DMD drive unit 38 drives DMD panel 218 in accordance with DMD control signal S14 from signal format conversion circuit 35.

Signal format conversion circuit 35 both controls the image-forming operation by DMD drive units 37 and 38 on the basis of the B signal supplied from scaler 33 and the RG signal supplied from scaler 34 and controls the color wheel rotation operation by color wheel drive unit 36 in synchronization with this image-forming operation.

In the control of the image-forming operation, signal format conversion circuit 35 both causes successive formation on DMD panel 217 of a blue image based on the B signal and a green image based on the G signal and causes formation on DMD panel 218 of a red image based on the R signal.

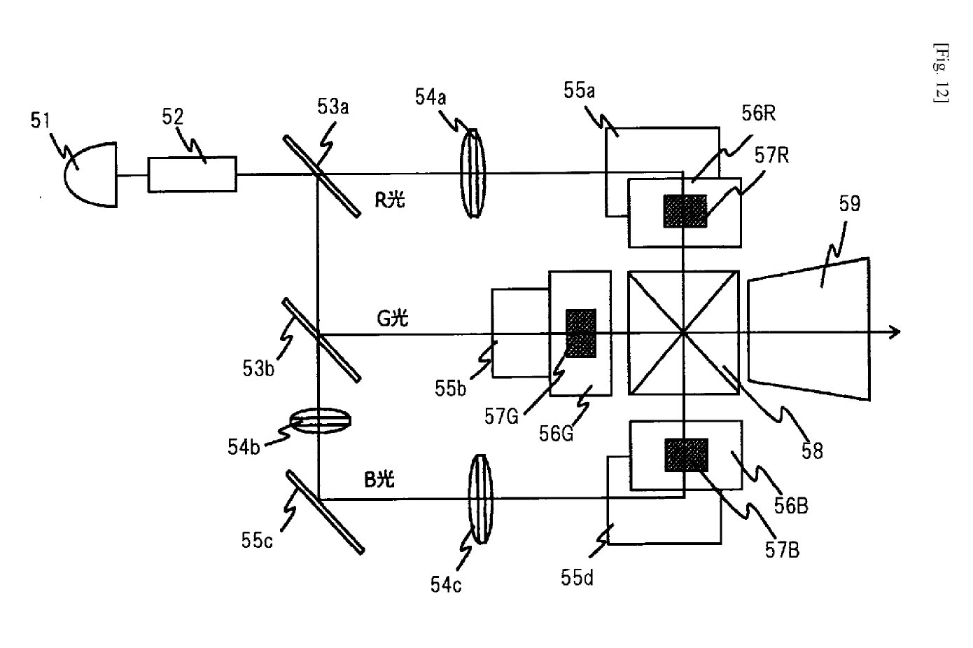

FIG. 11 shows the change over time of the color light that is irradiated upon DMD panels 217 and 218. Red light is always irradiated upon DMD panel 218. On the other hand, green light and blue light are alternately irradiated upon DMD panel 217. The irradiation interval (subfield interval) of blue light is shorter than the irradiation interval (subfield interval) of green light.

Signal format conversion circuit 35 constantly causes formation on DMD panel 218 of a red image based on the R signal. In addition, signal format conversion circuit 35 detects the irradiation interval (subfield interval) of the blue signal on the basis of rotation rate detection signal S11. Signal format conversion circuit 35 then causes formation on DMD panel 217 of a blue image that is based on the B signal in the irradiation interval of blue light and causes formation on DMD panel 217 of a green image that is based on the G signal in other intervals (the irradiation interval of green light).

In relation to the blue image, signal format conversion circuit 35 causes formation of an image with, as the pixel units, pixel combinations that are made up of a plurality of pixels, for example, pixel combinations of four adjacent pixels in two rows and two columns. In this way, a blue image that takes as pixel units pixel combinations that are formed by four pixels A, B, C, and D in two rows and two columns such as shown in FIG. 3B is formed on DMD panel 217. Signal format conversion circuit 35 then carries out ON/OFF control necessary for gradation display with respect to each micromirror that makes up the pixel combinations. In other words, signal format conversion circuit 35 carries out control that combines PWM modulation control and luminance control of pixel combinations. This control is as described in the first example embodiment.

In relation to the green image, on the other hand, signal format conversion circuit 35 causes formation on DMD panel 217 of an image of 1920 (horizontal)×1080 (vertical) resolution as shown in FIG. 3A. In relation to the red image, signal format conversion circuit 35 similarly causes formation on DMD panel 218 of an image of 1920 (horizontal)×1080 (vertical) resolution.

According to the image display device of the present example embodiment, in relation to a blue image, the number of tones of a blue image can be increased by forming an image with pixel combinations as pixel units, and moreover, by individually controlling each pixel of the pixel combinations. Although the resolution of the blue image drops, a red image and green image can be formed at the maximum resolution of the DMD panel, and a color image that is composed of the blue image, red image, and green image can be observed as a high-detail image with excellent tonality.

The modification described in the first example embodiment can also be applied in the present example embodiment.

### Third Example Embodiment

FIG. 12 gives a schematic representation of the block configuration of the optical system of the image display device according to the third example embodiment of the present invention.

Referring to FIG. 12, the image display device is a three-panel projector and includes white light source 51, light-homogenizing element 52, dichroic mirrors 53a and 53b, lenses 54a-54c, mirrors 55a-55d, TIR prisms 56R, 56G, and 56B, DMD panels 57R, 57G, and 57B, cross-dichroic prism 58, and projection lens 59.

White light source 51 is a solid-state light source such as an LED or a mercury lamp. Light-homogenizing element 52 is a component that is made up of an optical element such as a rod integrator or a light tunnel. Light-homogenizing element 52 supplies, to DMD panels 57R, 57G, and 57B, light for which the shape of the light beam is rectangular and the optical intensity distribution on a surface perpendicular to the center ray is homogenized. The white light from white light source 51 is incident to dichroic mirror 53a by way of light-homogenizing element 52.

Dichroic mirror 53a transmits light of the red wavelength band and reflects light of shorter wavelength bands. The white light is separated into red light and green/blue light by dichroic mirror 53a. The red light that has passed through dichroic mirror 53a is incident to DMD panel 57R by way of lens 54a, mirror 55a and TIR prism 56R. The green and blue light that is reflected by dichroic mirror 53a is incident to dichroic mirror 53b.

Dichroic mirror 53b transmits light of the blue wavelength band and reflects light of longer wavelength bands. The green and blue light from dichroic mirror 53a is separated into blue light and green light by dichroic mirror 53b. The green light that is reflected by dichroic mirror 53b is irradiated into DMD panel 57G by way of mirror 55b and TIR prism 56G. The blue light that passes through dichroic mirror 53b is irradiated into DMD panel 57B by way of lenses 54b and 54c, mirrors 55c and 55d and TIR prism 56B.

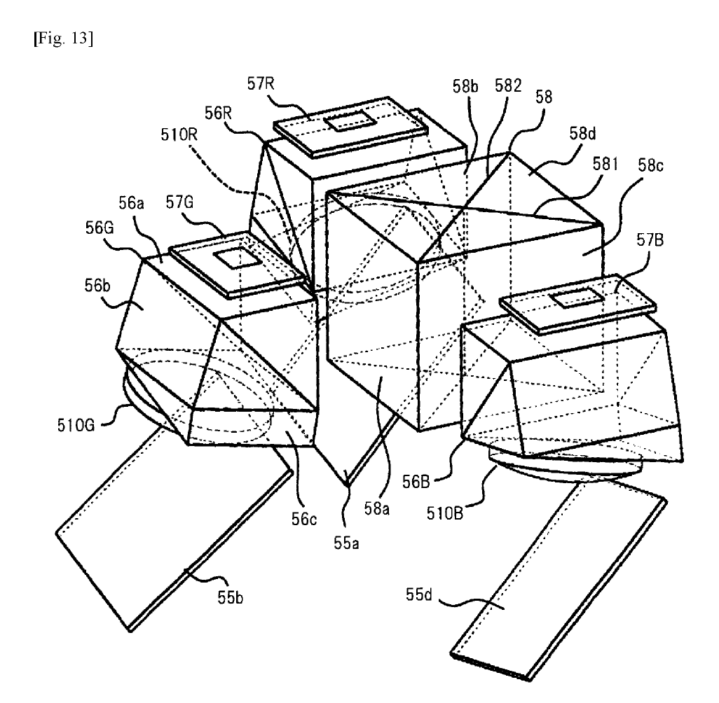

FIG. 13 gives a schematic representation of the disposition of mirrors 55a, 55b, and 55d, TIR prisms 56R, 56G, and 56B, DMD panels 57R, 57G, and 57B, and cross-dichroic prism 58.

Each of DMD panels 57R, 57G, and 57B has an image-forming surface made up of a plurality of micromirrors. DMD panels 57R, 57G, and 57b are arranged such that the image-forming surfaces of each are located on the same plane. In addition, the image-forming surfaces of each of DMD panels 57R, 57G, and 57B are directed in the same direction. In each of DMD panels 57R, 57G, and 57B, each micromirror is configured to change its angle according to the drive voltage, the reflecting angle differing when a drive voltage that indicates the ON state is supplied and when a drive voltage that indicates the OFF state is supplied. Incident luminous flux is spatially modulated to form an image by the ON/OFF control of each micromirror according to a video signal.

All of TIR prisms 56R, 56G, and 56B are polyhedral prisms in which a plurality of prisms are combined. TIR prisms 56R, 56G, and 56B are of the same configuration, and the configuration of TIR prism 56G is here described as an example.

TIR prism 56G includes three prisms 56a-56c. All of prisms 56a-56c are triangular-columnar prisms, and of these prisms, prism 56a is a right-angle prism in which the shape of the base surfaces is a right-angle triangle. The side surface that constitutes a base of the right-angle triangle of prism 56a and the side surface that constitutes a base of the triangle of prism 56b are of substantially the same size, and prisms 56a and 56b are arranged such that these side surfaces face each other over an interposed gap (air layer). The side surfaces that face these prisms 56a and 56b constitute the total reflection surfaces of TIR prism 56G.

The shape of the base surfaces of prism 56c is a triangle having an acute vertical angle. One of the side surfaces that constitute the vertical angle of the triangle of prism 56c and one of the side surfaces that constitute the vertical angle of the triangle of prism 56b are of substantially the same size, and these side surfaces are joined.

The other side surface that constitutes the vertical angle of the triangle of prism 56c is the incident surface of TIR prism 56G. Of the two side surfaces that constitute the vertical angle of the right-angle triangle of prism 56a, one side surface is the emission surface of TIR prism 56G, and the other side surface is the incident/emission surface of TIR prism 56G. TIR prism 56G is disposed such that its incident surface is located on the mirror 55b side, its emission surface is located on the dichroic prism 58 side, and its incident/emission surface is located on the DMD panel 57G side. TIR prism 56G may be made up of two prisms, prism 56a and prism 56b. In addition, prisms 56b and 56c may be a polyhedral configuration made up of one prism, and TIR prism 56G may be made up of this polyhedron and prism 56a.

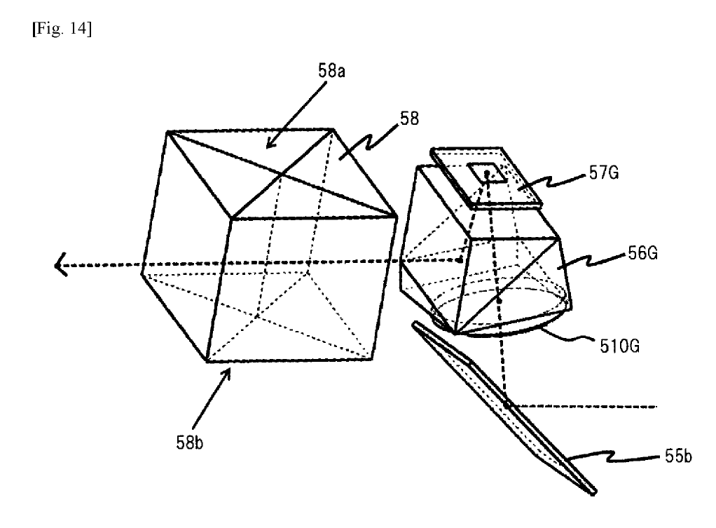

FIG. 14 is a schematic view showing the optical path of green light. In FIG. 14, the arrow shown by a broken line is the optical path of green light. In the interest of convenience, only the center ray of the green optical path is shown.

As shown in FIG. 14, the green light from mirror 55b is supplied to the incident surface of TIR prism 56G by way of field lens 510G. In TIR prism 56G, green light that is incident to the prism from the incident surface is incident to total-reflection surfaces at an angle of incidence that is smaller than the critical angle. As a result, the green light from mirror 55d is transmitted through the total-reflection surfaces and emitted from the incident/emission surface in the direction of DMD panel 57G.

The green light (image light) from DMD panel 57G is supplied to the incident/emission surface of TIR prism 56G. In TIR prism 56G, the green light that was irradiated into the prism from the incident/emission surface is irradiated into the total-reflection surface at an angle of incidence that is equal to or greater than the critical angle. As a result, the green light from DMD panel 57G is reflected at the total-reflection surface and emitted from the emission surface and toward dichroic prism 58.

TIR prism 56R is also of the same configuration as TIR prism 56G. Red light from mirror 55a is supplied to the incident surface of TIR prism 56R by way of field lens 510R. In TIR prism 56R, the red light that is incident to the prism from the incident surface is incident to the total-reflection surface at an angle of incidence that is smaller than the critical angle. As a result, the red light from mirror 55a is transmitted through the total-reflection surface and emitted from the emission surface in the direction of DMD panel 57R.

The red light (image light) from DMD panel 57R is supplied to the incident/emission surface of TIR prism 56R. In TIR prism 56R, the red light that is incident to the prism from the incident/emission surface is incident to the total-reflection surface at an angle of incidence that is equal to or greater than the critical angle. As a result, the red light from DMD panel 57R is reflected by the total-reflection surface and emitted from the emission surface in the direction of dichroic prism 58.

TIR prism 56B is also of the same construction as TIR prism 56R. Blue light from mirror 55d is supplied to the incident surface of TIR prism 56B by way of field lens 510B. In TIR prism 56B, the blue light that is incident to the prism from the incident surface is incident to the total-reflection surface at an angle of incidence that is smaller than the critical angle. As a result, the blue light from mirror 55d is transmitted through the total-reflection surface and emitted from the incident/emission surface toward DMD panel 57B.

The blue light (image light) from DMD panel 57B is supplied to the incident/emission surface of TIR prism 56B. In TIR prism 56B, the blue light that is irradiated into the prism from the incident/emission surface is incident to the total-reflection surface at an angle of incidence that is equal to or greater than the critical angle. As a result, the blue light from DMD panel 57B is reflected at the total-reflection surface and emitted from the emission surface in the direction of dichroic prism 58.

Dichroic prism 58 combines colors such that the images of the red image light, green image light, and blue image light are superposed, and this color-synthesized image light is supplied to projection lens 59. In other words, the direction of advance of the red image light, green image light, and blue image light is caused to coincide by dichroic prism 58.

Projection lens 59 enlarges and projects the red image light, green image light, and blue image light from dichroic prism 58.

The configuration of the processing/control portion relating to the display operation of the image display device of the present example embodiment is next described.

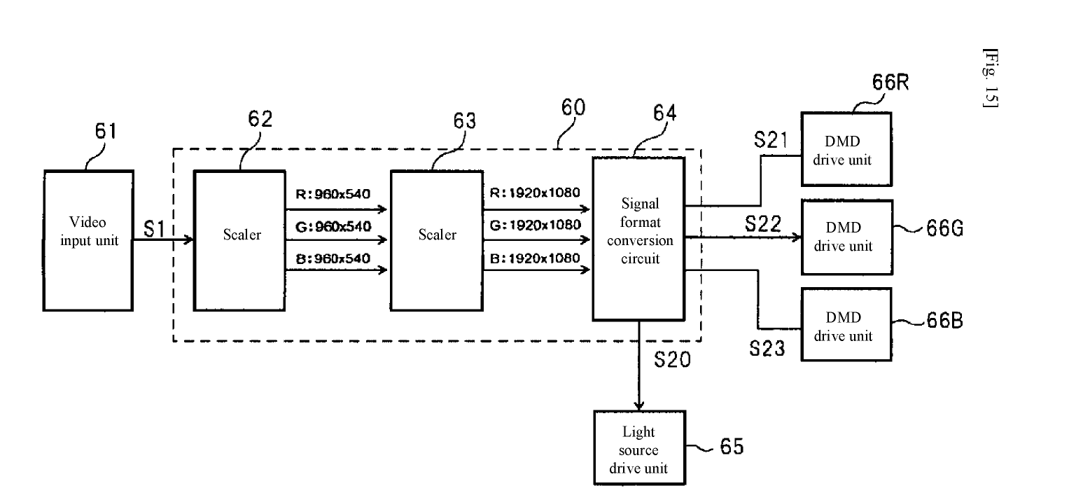

FIG. 15 is a block diagram showing the configuration of the processing/control portion of the image display device of the present example embodiment.

Referring to FIG. 15, the image display device includes control unit 60, video input unit 61, light source drive unit 65, and DMD drive units 66R, 66G, and 66B. Control unit 60 includes scalers 62 and 63 and signal format conversion circuit 64.

Video input unit 31 and scalers 62 and 63 are the same as video input unit 1 and scalers 2 and 3 shown in FIG. 1.

Video input unit 1 supplies video signal S1 to scaler 2. Scalers 2 and 3 are resolution conversion circuits that convert the resolution of video signal Si to the optimum resolution for display on DMD panels 57R, 57G, and 57B. In the interest of convenience, all of DMD panels 57R, 57G, and 57B have [1920 (horizontal)×1080 (vertical)] micromirrors and are here configured to provide a maximum of full HD resolution. However, the resolution of DMD panels 57R, 57G, 57B is not limited to full HD.

Scaler 2 converts the resolution of video signal Si to QHD (Quarter High Definition), which is one-quarter of full HD. Scaler 2 supplies an RGB signal of resolution (960×540) to scaler 3. Scaler 3 converts the resolution of each of the RGB signals supplied from scaler 2 to the same resolution as full HD. Scaler 3 supplies an RGB signal of resolution (1920×1080) to signal format conversion circuit 64.

Light source drive unit 65 drives light source unit 51 in accordance with light source control signal S20 from signal format conversion circuit 64. Signal format conversion circuit 64 causes light source unit 51 to always light up in intervals in which the power source of the image display device is in the ON state (or in the standby state) or at least in intervals in which an RGB signal is supplied from scaler 63.

DMD drive unit 66R drives DMD panel 57R in accordance with light source control signal S21 from signal format conversion circuit 64. DMD drive unit 66G drives DMD panel 57G in accordance with light source control signal S22 from signal format conversion circuit 64. DMD drive unit 66B drives DMD panel 57B in accordance with light source control signal S23 from signal format conversion circuit 64. Signal format conversion circuit 64 controls the image-forming operations of DMD panels 57R, 57G, 57B by DMD drive units 66R, 66G, and 66B based on RGB signals of resolution (1920×1080).

In the control of the image-forming operation, signal format conversion circuit 64 causes formation on DMD panel 57R of a red image based on the R signal, causes formation on DMD panel 57G of a green image based on the G signal, and causes formation on DMD panel 57B of a blue image based on the B signal. The red image, green image, and blue image are formed at the same time.

Regarding each of the red image, green image, and blue image, signal format conversion circuit 35 causes formation of an image with, as pixel units, pixel combinations formed from a plurality of pixels, for example, pixel combinations formed by four adjacent pixels in two rows and two columns. In this way, images are formed on DMD panels 57R, 57G, 57B with, as pixel units, pixel combinations that are formed by four pixels A, B, C, and D in two rows and two columns such as shown in FIG. 3B. Signal format conversion circuit 64 then carries out ON/OFF control necessary for gradation display with respect to each micromirror that makes up pixel combinations. In other words, signal format conversion circuit 64 implements control that combines the luminance control of pixel combinations with PWM modulation control. This control is as described in the first example embodiment.

The image display device of the present example embodiment also exhibits the same action and effects as the first example embodiment.

In addition, the modifications described in the first example embodiment can also be applied in the image display device of the present example embodiment. For example, signal format conversion circuit 64 may cause formation of at least one image of the red image, green image, and blue image with, as the pixel units, pixel combinations formed by a plurality of pixels and individually control the ON/OFF state of each pixel of pixel combinations. Here, at least one image may be taken as the blue image.

In the present example embodiment, moreover, a red solid-state light source that supplies as output red light having its center wavelength in the red wavelength band, a green solid-state light source that supplies green light having its center wavelength in the green wavelength band, and a blue solid-state light source that supplies blue light having its center wavelength in the blue wavelength band may be used in place of light source unit 51. The red light from the red solid-state light source is irradiated into DMD panel 57R, the green light from the green solid-state light source is irradiated into DMD panel 57G, and the blue light from the blue solid-state light source is irradiated into DMD panel 57B.

Further, a light source that uses a phosphor may also be used in place of light source unit 51. For example, this light source is made up of an excitation light source that supplies excitation light (for example, blue light) and a phosphor wheel. The phosphor wheel includes a red phosphor region, a green phosphor region, and a blue phosphor region, and is configured such that the excitation light is successively irradiated upon the red phosphor region, the green phosphor region, and the blue phosphor region. The red phosphor region contains a phosphor that, upon receiving the excitation light, emits red fluorescent light. The green phosphor region contains a phosphor that, upon receiving the excitation light, emits green fluorescent light. The blue phosphor region contains a phosphor that, upon receiving the excitation light, emits blue fluorescent light. The red fluorescent light from the red phosphor region is irradiated into DMD panel 57R, the green fluorescent light from the green phosphor region is irradiated into DMD panel 57G, and the blue fluorescent light from the blue phosphor region is irradiated into DMD panel 57B. In this case, light source drive unit 65 has the same functions as color wheel drive unit 36 that was described in the second example embodiment. For example, light source drive unit 65 causes the phosphor wheel to rotate in accordance with a rotation control signal from signal format conversion circuit 64 and supplies a rotation rate detection signal that indicates the rotation rate to signal format conversion circuit 64. Signal format conversion circuit 64 controls the image-forming operation in synchronization with the rotation operation of the phosphor wheel. Signal format conversion circuit 64 detects the irradiation interval (subfield interval) of each of the red fluorescent light, green fluorescent light, and blue fluorescent light on the basis of the rotation rate detection signal. Signal format conversion circuit 64 causes formation of a red image in the irradiation interval of the red fluorescent light, causes formation of a green image in the irradiation interval of the green fluorescent light, and causes formation of a blue image in the irradiation interval of the blue fluorescent light.

### Fourth Example Embodiment

The image display device of the fourth example embodiment is of the same configuration as the image display device of the first example embodiment but a portion of the image-forming control by signal format conversion circuit 4 differs from the first example embodiment.

When causing formation on DMD panel 109 of an image with pixel combinations composed of a plurality of pixels as pixel units in the present example embodiment, signal format conversion circuit 4 switches the combination patterns of the pixels of the ON state and the pixels of the OFF state of pixel combinations within a one-field interval.

For example, when a pixel combination is made up of four pixels A, B, C, and D in two rows and two columns, signal format conversion circuit 4 holds in advance data that indicates the pattern of each luminance shown in FIG. 4. When the luminance of a pixel combination is to be 25%, signal format conversion circuit 4 uses two or more patterns among the first to fourth patterns that indicate 25% luminance to switch the combination. When the luminance of a pixel combination is to be 50%, signal format conversion circuit 4 uses two or more patterns among the first to sixth patterns that indicate 50% luminance to switch the combination. When the luminance of a pixel combination is to be 75%, signal format conversion circuit 4 uses two or more patterns among the first to fourth patterns that indicate 75% luminance to switch the combination. The switching of the combination pattern can be applied to each of the red image, green image, and blue image.

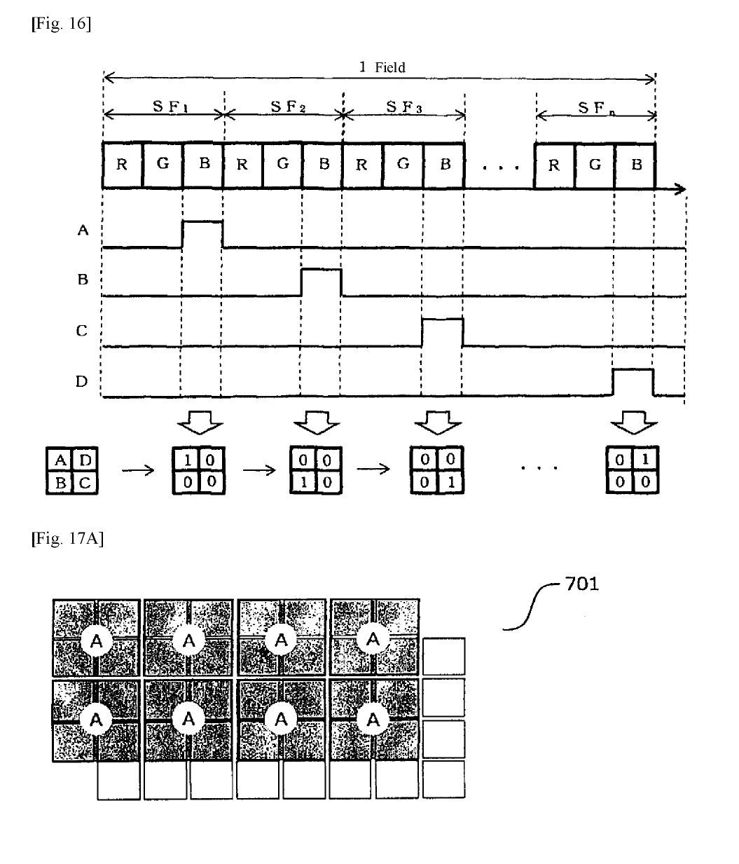

FIG. 16 shows an example of the switching operation of combination patterns that relate to a blue image. In this example, the pixel combination is made up of four pixels A, B, C, and D in two rows and two columns, and for a blue image, signal format conversion circuit 4 uses the first to fourth patterns that indicate 25% luminance to switch the combination within a one-field interval. One field is composed of n subfields SFₙ. Here, n is assumed to be a multiple of 4, but n is not limited to this value.

In the interval of subfield SF₁, signal format conversion circuit 4 places pixel A in the ON state and places each of pixels B, C, and D in the OFF state (the first pattern of 20% luminance shown in FIG. 4). In the interval of subfield SF₂, signal format conversion circuit 4 places pixel B in the ON state and places each of pixels A, C, and D in the OFF state (the second pattern of 20% luminance shown in FIG. 4). In the interval of subfield SF₃, signal format conversion circuit 4 places pixel C in the ON state and places each of pixels A, B, and D in the OFF state (the third pattern of 20% luminance shown in FIG. 4). In the interval of subfield SF₄, signal format conversion circuit 4 places pixel D in the ON state and places each of pixels A, B, and C in the OFF state (the fourth pattern of 20% luminance shown in FIG. 4).

Signal format conversion circuit 4, by switching the combination pattern of the ON-state pixels and OFF-state pixels of a pixel combination within a one-field interval, causes the bright spot within a pixel combination to move, with the result that the luminance distribution of the pixel combinations that is observed in a one-field interval can be made uniform. In this way, for example, an outline or a slanting line can be depicted as a smooth line.

The switching operation of the combination pattern can also be carried out for the red image and green image as for the blue image.

The switching of the combination pattern of ON-state pixels and OFF-state pixels of a pixel combination described in this example embodiment can be applied to any of the image display devices of the second and third example embodiments. When the switching of combination patterns is applied to the third example embodiment, the image of one frame is formed by images of a plurality of subframes, and the combination pattern of ON-state pixels and OFF-state pixels of a pixel combination is switched within a field interval that is the time unit for displaying the image of one frame.

The image display devices of each of the above-described example embodiments are merely examples of the present invention, and the configuration and operation are open to alteration as appropriate.

For example, in the image display device of the first example embodiment, signal format conversion circuit 4 may also carry out a pixel-shifting process when causing formation of an image on DMD panel 109 with pixel combinations made up of a plurality of pixels as pixel units. More specifically, signal format conversion circuit 4 causes formation of a frame image by successively forming a plurality of images with pixel combinations made up of a plurality of pixels as the pixel units, and of these images, for two images that are temporally continuously formed, one image is formed at a position shifted in a predetermined direction by a distance that corresponds to the pixel pitch of DMD panel 109 with relation to the other image.

For example, for each of images of the colors red, green, and blue, signal format conversion circuit 4, on the basis of an RGB signal, divides the image field into first and second subfields that are the time units of displaying a one-frame image and generates image signals G1 and G2 corresponding to each of the subfields.

In the first subfield interval, DMD drive unit 6 causes formation on DMD panel 109 of an image based on image signal G1. In the second subfield interval, DMD drive unit 6 causes formation on DMD panel 109 of an image based on image signal G2.

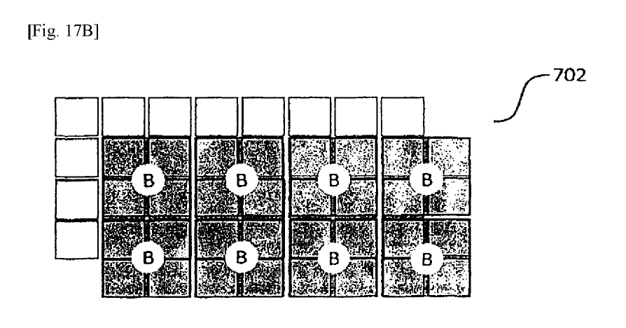

FIG. 17A shows image formation region 701 in which one portion of image A is formed based on image signal G1, and FIG. 17B shows image formation region 702 in which one portion of image B is formed based on image signal G2. These images A and B are both formed with pixel combination composed of four pixels in two rows and two columns as unit pixels.

As shown in FIG. 17A and 17B, image formation region 702 is shifted by one pixel in the direction in both the vertical direction (column direction) and horizontal direction (row direction) with respect to image formation region 701. In other words, image formation region 702 is shifted obliquely toward the lower right with respect to image formation region 701. Here, the oblique direction toward the lower right is equivalent to the diagonal direction of the pixel combination.

According to the above-described pixel shifting control, image A based on image signal G1 and image B based on image signal G2 are displayed in time divisions on the projection surface for each of the images of each color red, green, and blue. Due to the afterimage phenomenon of the human eye, an image is observed in which image A and image B are superposed.

As shown in FIG. 17A and FIG. 17B, by shifting the image formation region shared by images A and B by one pixel in both the vertical direction and horizontal direction, the pixels (i.e., pixel combinations) corresponding to images A and B are shifted by 0.5 pixel in both the vertical direction and horizontal direction on the projection surface. In this case, the superposed image of image A and image B is observed as an image having a number of pixels that corresponds to the number of pixels of DMD panel 109. In this way, any drop in the resolution of an image that is created when the image is displayed with pixel combinations as the unit pixels can be reduced.

In this example, images that are formed in time divisions should be images formed with pixel combinations composed of n (rows)×m (columns) of pixels as unit pixels. Here, n and m are positive integers (excepting a case in which n=1, and moreover, m=1). In this case, various pixel combination formats such as 1×2, 2×1, 2×2, and 3×3 can be achieved.

For example, when a first and second image are formed in time divisions with pixel combinations composed of two pixels in one row and two columns as unit pixels, the image formation region shared between the first and second images is shifted by one pixel in the column direction. In this case, the observed image is an image in which the number of pixels in the column direction is doubled.

When a first and second image are formed in time divisions with pixel combinations composed of two pixels in two rows and one column as the unit pixel, the image formation region shared between the first and second image is shifted by one pixel in the row direction. In this case, the observed image is an image in which the number of pixels in the row direction is doubled.

When an image is formed in time divisions with pixel combinations composed of nine pixels in three rows and three columns as the unit pixels, first to third image signals that indicate each of first to third images are generated. Further, one frame is divided into first to third subframes (or subfields). A first image that is based on a first image signal is then formed in the interval of the first subframe, a second image that is based on a second image signal is formed in the interval of the second subframe, and a third image that is based on a third image signal is formed in the interval of the third subframe. In this case, the image formation region shared between the first and second images is shifted by one pixel in the directions both the row direction and the column direction. Further, the image formation region shared between the second and third images is shifted by one pixel in the directions of each of the row direction and column direction. In this way, a higher-definition image can be provided in which the number of pixels of the observed image is increased compared to a case in which a pixel combination is made up of four pixels in two rows and two columns.

The pixel shifting control of this example can be applied to any image display device of the second to fourth example embodiments. In the second example embodiment, for example, pixel shifting control is implemented for the blue image.

In the above-described example embodiments and modifications, DMD panels were used as the image forming means, but the present invention is not limited to this form. A liquid crystal panel can also be used as the image forming means.

Further, the present invention is not limited to projectors. The present invention can also be applied in direct-view monitor, for example, in a MEMS (Micro Electro Mechanical System) display.

This application incorporates all of the content disclosed in International Application No. PCT/JP2014/052863 for which international application was submitted on Feb. 7, 2014.

In addition, the present invention can adopt forms such as shown in the following SUPPLEMENTARY NOTES 1-14 but is not limited to these forms.

### [Supplementary Note 1]

An image display device includes:

a light source unit;

image formation means that is provided with a pixel region made up of a plurality of pixels, this pixel region being irradiated by light that is supplied from the light source unit, and an image being formed by modulation of incident light by each pixel; and

control means that controls the image-forming operation of the image formation means;

wherein the control means causes formation of an image with pixel combinations formed by a plurality of pixels as pixel units and individually controls the ON state and OFF state of each pixel of the pixel combinations.

### [Supplementary Note 2]

In the image display device as described in SUPPLEMENTARY NOTE 1, the control means switches the ON state and OFF state of each pixel that makes up the pixel combinations on the basis of a video signal that is received as input and controls the ON-state pixels by means of pulse-width modulation.

### [Supplementary Note 3]

In the image display device as described in SUPPLEMENTARY NOTE 2: a field that is the time unit for displaying the image of one frame is made up of a plurality of subfields provided with a time width that corresponds to each of a plurality of bits; and the control means generates a modulation signal on the basis of the plurality of bits based on the video signal, and both carries out the pulse width modulation in accordance with the modulation signal and individually switches the ON state and OFF state of each pixel of the pixel combinations to control the luminance of the pixel combinations in at least the interval of the smallest bit of the modulation signal.

### [Supplementary Note 4]

In the image display device as described in any one of SUPPLEMENTARY NOTES 1 to 3, in a field interval that is the time unit for displaying the image of one frame, the control means switches the combination of ON-state pixels and OFF-state pixels of the pixel combinations such that the proportion of ON-state pixels and OFF-state pixels does not change.

### [Supplementary Note 5]

In the image display device as described in any one of SUPPLEMENTARY NOTES 1 to 4, the control means causes formation of frame images by successively forming a plurality of images with the pixel combinations as pixel units, and for two images of the plurality of images that are formed in temporal continuity, forms one image at a position shifted by a distance corresponding to the pixel pitch of the pixel region in a predetermined direction with respect to the other image.

### [Supplementary Note 6]

In the image display device as described in SUPPLEMENTARY NOTE 5, the pixel combinations are composed of four pixels in two rows and two columns and the predetermined direction is the row direction and the column direction.

### [Supplementary Note 7]

In the image display device as described in any one of SUPPLEMENTARY NOTES 1 to 6:

the image formation means successively or simultaneously forms a red image, green image, and blue image; and

the control means causes formation of at least the blue image with the pixel combinations as the pixel units.

### [Supplementary Note 8]

The image display device as described in any one of SUPPLEMENTARY NOTES 1 to 7 further includes a projection lens that projects an image that is formed by the image formation means.

### [Supplementary Note 9]

An image display method that is carried out in an image display device that is provided with a pixel region that is made up of a plurality of pixels and in which an image is formed by the modulation of incident light by each pixel, the method including:

forming an image in the pixel region with pixel combinations that are formed by a plurality of pixels as pixel units; and

individually controlling the OFF state and ON state of each pixel that makes up the pixel combinations.

### [Supplementary Note 10]

The image display method as described in SUPPLEMENTARY NOTE 9 further includes: switching the ON state and OFF state of each pixel that makes up the pixel combinations on the basis of a video signal that is received as input; and

controlling the ON-state pixels by pulse-width modulation.

### [Supplementary Note 11]

In the image display method as described in SUPPLEMENTARY NOTE 10, a field that is the time unit for displaying images of one frame is made up of a plurality of subfields provided with a time width that correspond to each of a plurality of bits; and the image display method further includes: generating a modulation signal based on the plurality of bits on the basis of the video signal; and both implementing the pulse width modulation according to the modulation signal and switching the ON state and OFF state of each pixel of the pixel combinations to control luminance of the pixel combinations in at least the interval of the smallest bit of the modulation signal.

### [Supplementary Note 12]

The image display method as described in any one of SUPPLEMENTARY NOTES 9 to 11 further includes switching combinations of ON state pixels and OFF-state pixels of the pixel combinations within the field interval that is the time unit for displaying images of one frame such that the proportion of ON-state pixels and OFF-state pixels does not change.

### [Supplementary Note 13]

The image display method as described in any one of SUPPLEMENTARY NOTES 9 to 12 further includes: causing the formation of frame images by successively forming a plurality of images with the pixel combinations as pixel units; and for two images of the plurality of images that are formed in temporal continuity, causing formation of one image at a position that is shifted by a distance that corresponds to the pixel pitch of the pixel region in a predetermined direction with respect to the other image.

### [Supplementary Note 14]

In the image display method as described in SUPPLEMENTARY NOTE 13, the pixel combinations are made up of four pixels in two rows and two columns and the predetermined direction is the row direction and the column direction.

### EXPLANATION OF REFERENCE NUMBERS

1 video input unit

2, 3 scaler

4 signal format conversion circuit 4

5 light source drive unit

6 DMD drive unit

10 control unit

11a, 11b dichroic mirror

11R, 11G, 11B light source

102 condensing lens

103 light tunnel

104-106 lens system

107 reflecting mirror

108 TIR prism

109 DMD panel

110 projection lens

1. An image display device comprising:
a light source unit;
an image formation unit that is provided with a pixel region made up of a plurality of pixels, said pixel region being irradiated by light that is supplied from said light source unit, and an image being formed by modulation of incident light by each pixel; and
a controller that controls an image-forming operation of said image formation unit;
wherein said controller causes formation of an image with pixel combinations formed by a plurality of pixels as pixel units and individually controls the ON state and OFF state of each pixel of said pixel combinations.

2. The image display device as set forth in claim 1, wherein said controller switches the ON state and OFF state of each pixel that makes up said pixel combinations on the basis of a video signal that is received as input and controls the ON-state pixels by means of pulse-width modulation.

3. The image display device as set forth in claim 2, wherein a field that is the time unit for displaying the image of one frame is made up of a plurality of subfields provided with a time width that corresponds to each of a plurality of bits; and said controller generates a modulation signal on the basis of said plurality of bits based on said video signal, and both carries out said pulse width modulation in accordance with said modulation signal and individually switches the ON state and OFF state of each pixel of said pixel combinations to control the luminance of said pixel combinations in at least the interval of a smallest bit of said modulation signal.

4. The image display device as set forth in claim 1, wherein in a field interval that is the time unit for displaying the image of one frame, said controller switches the combination of ON-state pixels and OFF-state pixels of said pixel combinations such that the proportion of ON-state pixels and OFF-state pixels does not change.

5. The image display device as set forth in claim 1, wherein said controller causes formation of frame images by successively forming a plurality of images with said pixel combinations as pixel units, and for two images of said plurality of images that are formed in temporal continuity, forms one image at a position shifted by a distance corresponding to a pixel pitch of said pixel region in a predetermined direction with respect to the other image.

6. The image display device as set forth in claim 5, wherein said pixel combinations include four pixels in two rows and two columns and said predetermined direction is the row direction and the column direction.

7. The image display device as set forth in claim 1, wherein:
said image formation unit successively or simultaneously forms a red image, green image, and blue image; and
said controller causes formation of at least said blue image with said pixel combinations as the pixel units.

8. The image display device as set forth in claim 1, further comprising a projection lens that projects an image that is formed by said image formation unit.

9. An image display method that is carried out in an image display device that is provided with a pixel region that is made up of a plurality of pixels and in which an image is formed by modulation of incident light by each pixel, said image display method comprising:
forming an image in said pixel region with pixel combinations that are formed by a plurality of pixels as pixel units; and
individually controlling the ON state and OFF state of each pixel that makes up said pixel combinations.

10. The image display method as set forth in claim 9, further comprising:
switching the ON state and. OFF state of each pixel that makes up said pixel combinations on the basis of a video signal that is received as input; and
controlling the ON-state pixels by pulse-width modulation.

11. The image display method as set forth in claim 10, wherein a field that is the time unit for displaying images of one frame is made up of a plurality of subfields provided with a time width that corresponds to each of a plurality of bits, said image display method further comprising:
generating a modulation signal based on said plurality of bits on the basis of said video signal; and
both implementing said pulse width modulation according to said modulation signal and switching the ON state and OFF state of each pixel of said pixel combinations to control luminance of said pixel combinations in at least the interval of a smallest bit of said modulation signal.

12. The image display method as set forth in claim 9, further comprising switching combinations of ON state pixels and OFF-state pixels of said pixel combinations within a field interval that is the time unit for displaying images of one frame such that the proportion of ON-state pixels and OFF-state pixels does not change.

13. The image display method as set forth in claim 9, further comprising causing the formation of frame images by successively forming a plurality of images with said pixel combinations as pixel units; and for two images of said plurality of images that are formed in temporal continuity, causing formation of one image at a position that is shifted by a distance that corresponds to a pixel pitch of said pixel region in a predetermined direction with respect to the other image.

14. The image display method as set forth in claim 13, wherein said pixel combinations include four pixels in two rows and two columns and said predetermined direction is the row direction and the column direction.
